(19) United States
(12) Patent Application Publication
(10) Pub. No.: US 2026/0330559 A1
(43) Pub. Date: Oct. 22, 2026

(54) SYSTEMS AND METHODS FOR BROWSER-MEDIATED CROSS-PLATFORM ARTIFICIAL INTELLIGENCE EXECUTION WITH CONTEXT INJECTION, FEDERATED WORKFLOW EXCHANGE, AND HUMAN-IN-THE-LOOP CONTROL INTERFACES

(71) Applicant: Matthew Gene Struble, Indialantic, FL (US)

(72) Inventor: Matthew Gene Struble, Indialantic, FL (US)

(21) Appl. No.: 19/633,916

(22) Filed: Mar. 30, 2026

Related U.S. Application Data
(63) Continuation-in-part of application No. 19/546,463, filed on Feb. 23, 2026.

(51) Int. Cl. G06Q 40/06; G06Q 10/067

(52) U.S. Cl. CPC G06Q 40/0631; G06Q 10/067; G06Q 40/067

(57) ABSTRACT

A computer-implemented system and method for browser-mediated cross-platform artificial intelligence execution providing a persistent AI execution surface operating as a unified control plane. The system coordinates six integrated pillars through a shared execution state: a cross-platform AI context bridge that injects structured business record context into third-party AI platforms, an intelligent legal data acquisition system with multi-stage AI classification, a session-authenticated platform migration system using browser session credentials as proxy authentication, an AI execution visibility system with animated cursor tracking and interactive human decision controls, a vision-based damage assessment system with multi-source evidence fusion and provenance-linked estimates, and a federated execution protocol enabling secure cross-organizational coordination via cryptographic trust and selective replication. The system operates without reliance on application programming interfaces by performing interaction-layer manipulation of rendered user interfaces. A unified execution state and event-driven messaging architecture coordinates human-supervised execution across internal modules, external AI platforms, and federated computing nodes.

### FIELD OF THE INVENTION

The present invention relates generally to computer-implemented systems and methods for browser-mediated artificial intelligence execution across multiple platforms and organizational boundaries, and more specifically to systems providing cross-platform artificial intelligence context bridging via browser extension content scripts, federated workflow exchange between independently operated computing nodes using cryptographic trust and selective replication, session-authenticated platform migration using browser session credentials as proxy authentication, real-time artificial intelligence execution visibility with human-in-the-loop decision interfaces, intelligent legal data acquisition with multi-stage artificial intelligence classification pipelines, and vision-based property damage assessment with multi-source evidence fusion for automated estimate generation and dispute analysis.

### BACKGROUND OF THE INVENTION

Modern professional service environments require seamless interaction with multiple disconnected platforms—case management systems, AI assistants, court portals, insurance systems, document repositories, and financial systems. Within a single matter or claim, a professional must context-switch between these systems, each maintaining isolated information silos. Business context—client facts, claim details, legal precedent, financial data—exists in one system but must be manually recreated in another. This fragmentation creates inefficiency, introduces error, and prevents AI assistants from fully leveraging the rich context available within the organization systems.

Existing artificial intelligence assistants—including general-purpose platforms such as ChatGPT, Claude, and other large language models—operate as isolated, closed platforms. Users manually copy data and context from their business systems and paste it into the AI platform text input fields. There is no structured way to inject business record context into third-party AI platforms, no API-based integration for most SaaS tools, and no mechanism for the AI to request additional context when needed. The user bears the burden of context assembly and manual entry, and the AI assistant lacks visibility into the authoritative source systems.

Platform migration between Software-as-a-Service tools—such as Clio, MyCase, Filevine, and other case management systems—requires manual data re-entry or expensive custom API integrations. When a user switches from one case management system to another, or when two firms need to collaborate using different platforms, data must be extracted, transformed, and re-entered. Browser session authentication—the credentials and session tokens the user maintains through browser cookies and storage—is not leveraged for automated, frictionless migration. Users must authenticate separately in each system, and data transfer is manual or restricted to bulk export/import cycles.

Artificial intelligence execution within business tools and workflows operates as a black box. Users cannot see what the AI is doing, what information it is processing, where it is in a multi-step workflow, or whether it is waiting for human decision input. No cursor-based execution visualization or step-rail interface exists to provide real-time feedback on AI execution progress. Users cannot intervene mid-execution at critical decision points, modify execution state, or resume interrupted workflows. The gap between AI execution and human supervision undermines trust and accountability in professional contexts.

Legal data acquisition from court portals, document repositories, and regulatory databases requires manual downloading, reading, and classification by humans. No automated multi-stage artificial intelligence classification pipeline exists to analyze incoming court filings, extract findings, classify document types, assess legal significance, and organize data into structured, actionable form. Court portal access is highly portal-specific, requiring different navigation sequences and authentication mechanisms for different jurisdictions and filing systems.

Property damage assessment, insurance claim processing, and contractor estimation in the property and casualty domain rely on manual estimation processes. Existing tools do not systematically fuse multiple evidence sources—photograph-based visual analysis, weather data, regional pricing factors, and applicable building codes—into unified, provenance-tracked estimates. Estimates lack explicit connection to evidence, making comparison between independent estimates difficult and dispute resolution uncertain. No learning loop exists to improve estimates as new market data arrives.

Cross-organizational workflow coordination between independently operated professional service firms—such as law firms, engineering firms, and insurance companies—lacks structured protocols and cryptographic trust mechanisms. Existing approaches rely on informal email, phone calls, and unstructured document sharing, with no end-to-end authentication, selective data replication policies, or structured workflow message objects. Firms cannot coordinate execution across organizational boundaries with confidence that data remains confidential and execution proceeds according to agreed-upon rules.

### SUMMARY OF THE INVENTION

The present invention provides a comprehensive system and method for browser-mediated cross-platform artificial intelligence execution, structured federated workflow coordination, and human-in-the-loop decision interfaces. The invention transforms fragmented, manual AI interactions into a coordinated execution fabric that spans internal business systems, third-party AI platforms, and federated computing nodes across organizational boundaries.

The Cross-Platform AI Context Bridge (Pillar A) comprises a browser extension that detects input elements within third-party AI platforms using sequential detection strategies, injects structured business context into those platforms without requiring API integration, supports context chunking with semantic boundary preservation, maintains bidirectional synchronization between source systems and the AI platform, and handles authentication transparently through the browser session. The bridge enables users to enrich AI queries with full business context—client facts, prior case outcomes, legal precedent, financial constraints—without manual copy-paste.

The no-API access principle is central to the context bridge. The system accesses third-party AI platforms solely via interaction-layer manipulation of rendered user interfaces—invoking native element property setters, simulating clipboard operations, and activating submission controls—without requiring application programming interface integration, API keys, vendor-provided integration mechanisms, or vendor cooperation. This approach enables integration with any AI platform that provides a web-based user interface, including proprietary platforms that do not publish APIs, and withstands platform UI changes through the resilience of sequential fallback strategies.

The Intelligent Legal Data Acquisition system (Pillar B) comprises a browser extension with jurisdiction-specific court portal adapters, an overlay interface for guided document download and interaction, and a multi-stage artificial intelligence classification pipeline. The system detects when a user navigates to a court portal, presents an interactive overlay, guides the user through finding relevant filings, downloads documents via chunked streaming, and automatically analyzes incoming filings using a sequence of specialized AI steps—filing analyzer, domain-aware classification pipeline, and structured observation generation.

The Session-Authenticated Platform Migration system (Pillar C) leverages browser session credentials as a proxy for authentication between platforms. When a user is authenticated in Platform A and wishes to migrate data to Platform B, the system uses the user active browser session in Platform A to extract data—without requiring the user to supply passwords or API keys—and transfers that data to Platform B. Fallback extraction strategies handle complex table structures, entity relationships, and platform-specific data models, with deep entity extraction ensuring semantic accuracy.

The AI Execution Visibility system (Pillar D) provides real-time visualization of AI execution through an animated execution cursor driven by execution event metadata, a step rail interface that serves as an auditable execution trace, a context chip displaying current execution context, and quick-reply decision controls that allow users to modify serialized execution state at decision points. Workflows are interruptible and resumable, with full state persistence, enabling humans to supervise and steer AI execution throughout.

The Vision-Based Damage Assessment system (Pillar E) analyzes photographs of property damage using artificial intelligence vision models—with fallback to multiple vision providers for resilience—correlates findings with weather evidence from the date and location of loss, applies regional pricing factors from a structured pricing database, incorporates applicable building codes and construction standards, generates detailed estimates with explicit provenance linking each finding to source evidence, and compares independent estimates to support dispute resolution and learning.

The Federated Execution Protocol (Pillar F) enables secure, structured coordination between independent computing nodes operated by different organizations. The protocol establishes cryptographic trust through asymmetric keypair exchange and challenge-response handshakes, manages shared record-scoped communication rooms with independent local representations at each node, uses structured workflow message objects for unambiguous data interchange, implements selective replication policies that filter sensitive data before cross-organization transmission based on AI context sensitivity, supports adaptive communication modality with protocol-enhanced and fallback modes, and maintains append-only event logs with cryptographic signatures and hash chains for complete auditability.

Within the federated protocol, AI-aware replication is a core innovation. Artificial intelligence outputs—which may contain sensitive reasoning, intermediate analysis, or privileged information—are filtered through replication policies before cross-organization transmission. The system evaluates AI context sensitivity dynamically, determining which portions of AI-generated content should be shared with federated partners based on data classification, legal privilege, and business policies.

Conflict resolution within the federated protocol uses deterministic ordering for concurrent updates across nodes. When two nodes update the same record simultaneously, the protocol applies a tie-breaking rule based on cryptographic ordering, ensuring that all nodes converge to the same state without requiring real-time coordination.

The Unified Execution Surface serves as a control plane coordinating internal modules, external AI platforms, and federated nodes through a unified execution state and event-driven messaging architecture. This surface unifies all six pillars into a single persistent AI execution environment, wherein each pillar is coordinated through shared execution state maintained by the execution surface, with human-in-the-loop decision making integrated throughout, transparent state persistence, and audit trails for compliance.

Through this comprehensive architecture, the invention transforms disconnected AI interactions into a coordinated execution fabric, enabling professional service organizations to leverage artificial intelligence across system boundaries while maintaining security, auditability, and human oversight.

### BRIEF DESCRIPTION OF THE DRAWINGS

FIG. 1 illustrates a system architecture diagram showing the overall structure of the invention, including a browser extension operating as a content script and service worker, a transactional application environment representing internal business systems, external third-party AI platform interfaces, and federated computing nodes operated by partner organizations.

FIG. 2 presents a block diagram of the cross-platform AI context bridge, illustrating the authenticated session bridge component, context assembly module, element detection engine, injection strategy selection engine, semantic boundary-preserving chunking module, and bidirectional synchronization module.

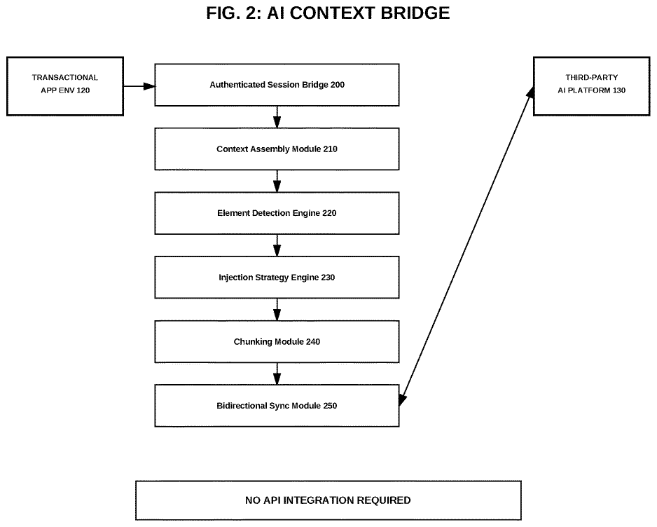

FIG. 3 shows a sequence diagram depicting the sequential element detection and injection strategy cascade, illustrating how the system attempts identifier-based detection, then attribute-based detection, then class-based detection, then aria-label-based detection, and finally element-type fallback detection.

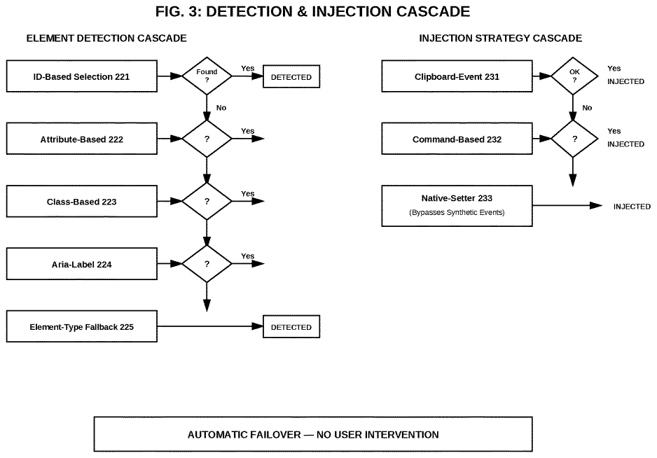

FIG. 4 presents a block diagram of the intelligent legal data acquisition system, illustrating the court portal adapter registry, multiple jurisdiction-specific adapter modules, overlay interface component, download controller, and the multi-stage AI analysis pipeline.

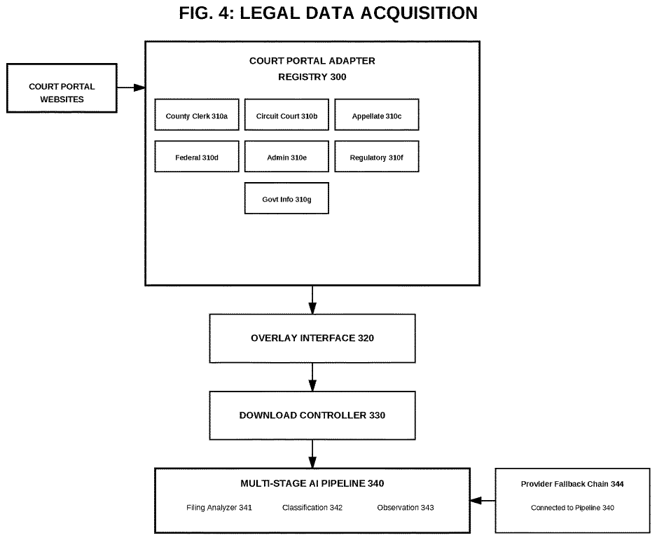

FIG. 5 shows a flowchart of the multi-stage AI analysis pipeline, depicting the filing analyzer stage, domain-aware classification pipeline stage, and structured observation generation stage, with provider fallback chains and integration with the case law library analytics module.

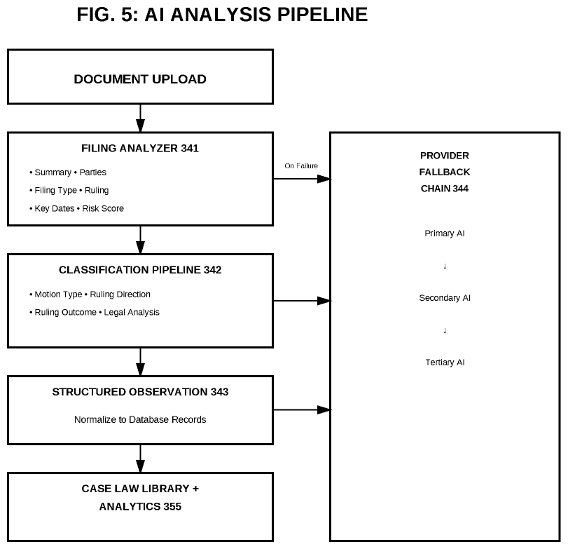

FIG. 6 presents a block diagram of the session-authenticated platform migration system, illustrating the credential proxy mechanism using browser session credentials, fallback extraction strategies, the deep entity extraction module, and batched transfer controller.

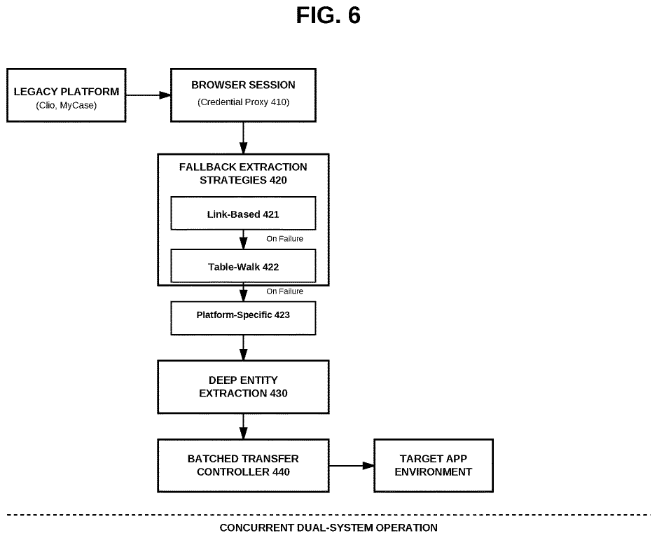

FIG. 7 shows a user interface diagram of the AI execution visibility system, illustrating the animated execution cursor, the step rail interface, the context chip displaying current execution state, quick-reply decision controls, and the unified communication inbox.

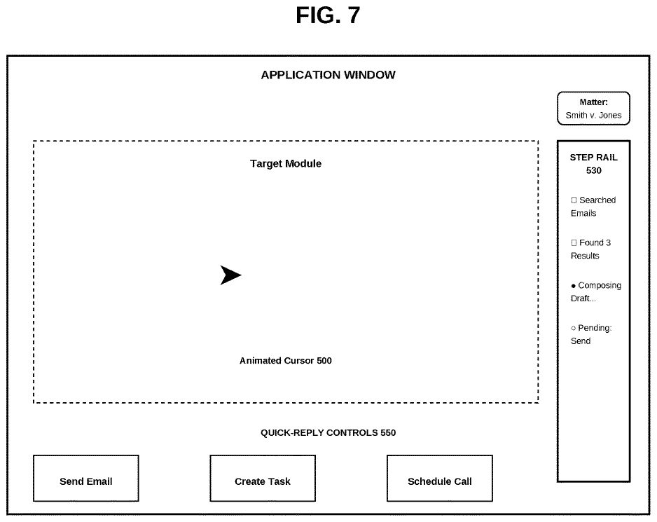

FIG. 8 presents a state diagram of staged workflow execution, illustrating decision points within an AI workflow, serialized state persistence mechanisms, workflow interruption and resumption capabilities, and state modification through quick-reply controls.

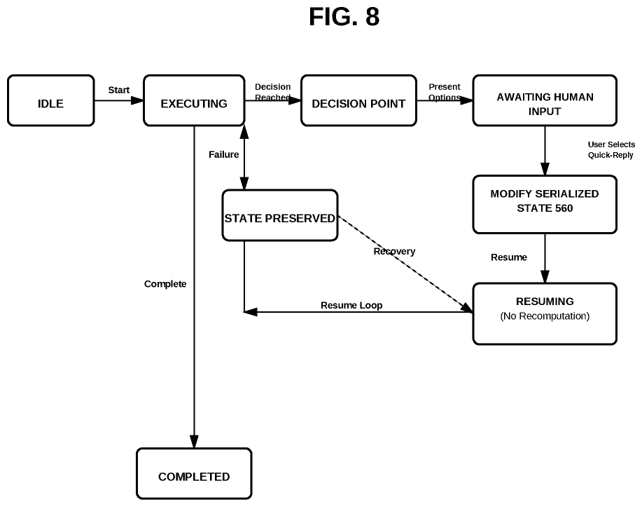

FIG. 9 shows a block diagram of the vision-based damage assessment system, illustrating the photo report module, AI vision analysis engine with provider fallback chains, weather evidence correlation module, regional pricing database, building code rules database, estimate generation engine, and explicit provenance linking.

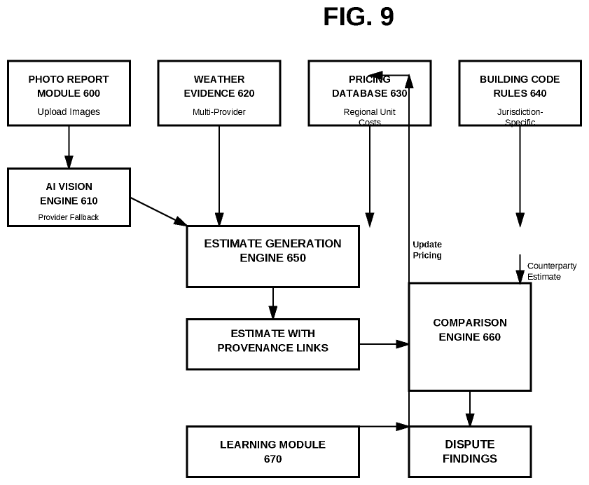

FIG. 10 presents a flowchart of the estimate comparison engine, showing the finding type classification process, evidence-linked finding structures, counterparty estimate comparison logic, and integration with the learning loop for estimate improvement.

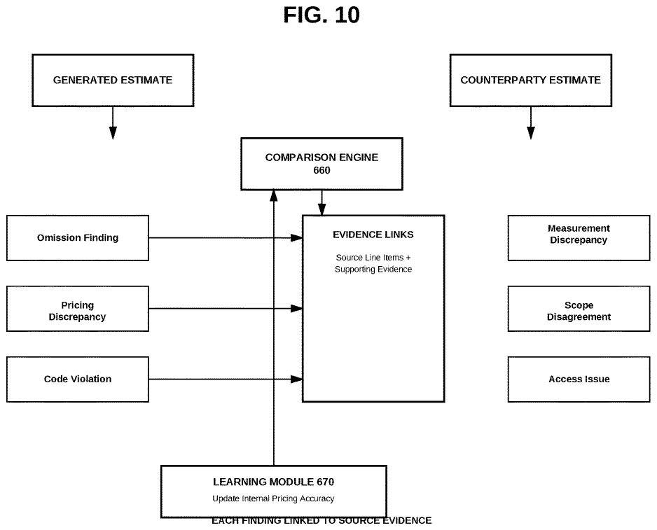

FIG. 11 illustrates a system architecture diagram of the federated execution protocol, showing computing nodes operated by different organizations, cryptographic trust establishment mechanisms, shared record-scoped communication rooms, and event synchronization pathways.

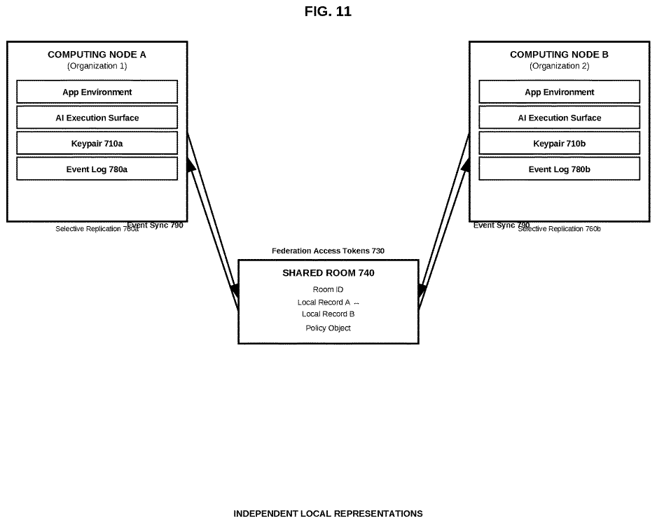

FIG. 12 shows a sequence diagram of the cryptographic challenge-response handshake protocol, illustrating the asymmetric keypair exchange, challenge generation, response computation and verification, and federation access token issuance.

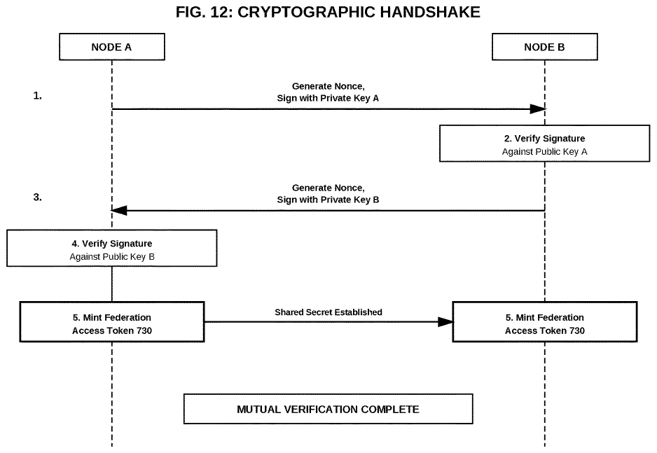

FIG. 13 presents a block diagram of the selective replication engine, illustrating domain classification logic, AI-aware filtering rules, dynamic evaluation based on AI context sensitivity, and policy evaluation components.

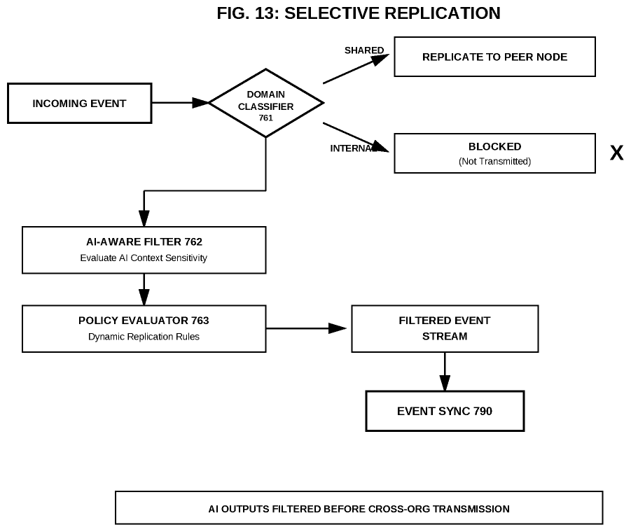

FIG. 14 shows a diagram of the adaptive modality engine, illustrating protocol-enhanced communication modes leveraging WebRTC, fallback communication modes using HTTP-based message passing, and mode selection logic.

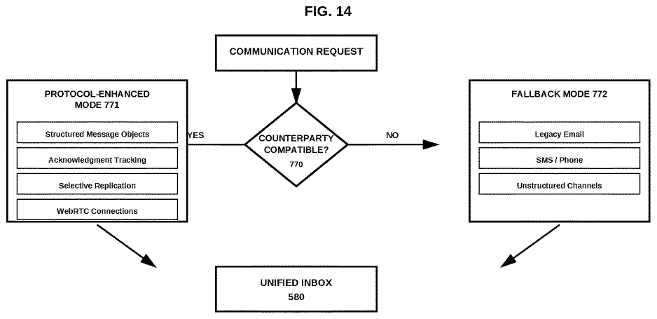

FIG. 15 presents a system overview diagram of the unified execution surface as a control plane, coordinating internal modules, external AI platforms, federated nodes, human decision interfaces, and audit trail components.

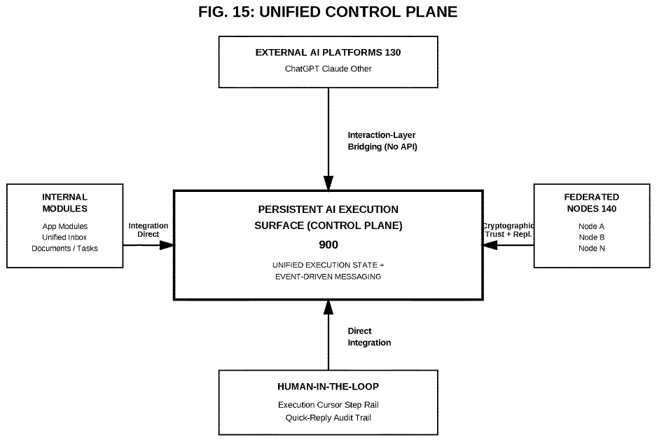

### DETAILED DESCRIPTION OF PREFERRED EMBODIMENTS

### System Architecture Overview

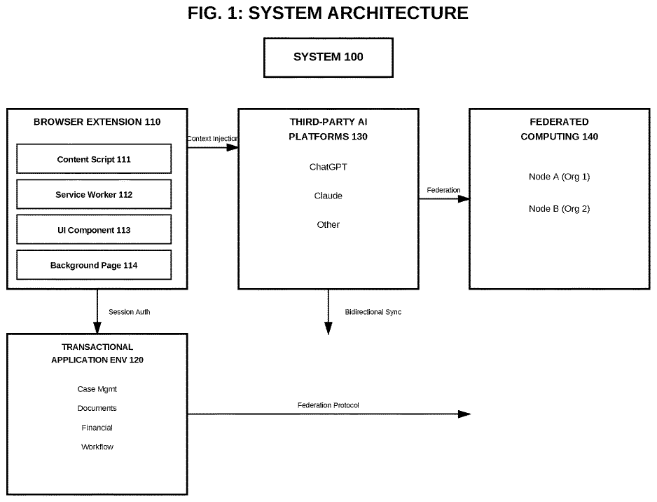

Referring to FIG. 1, the system 100 comprises a browser extension 110, a transactional application environment 120, connectivity to third-party AI platforms 130, and federated computing nodes 140. The browser extension operates as a distributed application with multiple components: a content script 111 that injects code into the DOM of web pages, a service worker 112 that maintains persistent state, a user interface component 113, and a background page 114. The transactional application environment 120 represents internal business systems including case management, document management, and financial systems. Third-party AI platforms 130 represent external AI services accessed through web-based interfaces. Federated computing nodes 140 represent independent infrastructure operated by external organizations that participates in the federated protocol for secure coordination.

The content script 111 operates with DOM access and executes in the context of web pages, allowing observation and manipulation of page elements. The service worker 112 operates in a privileged background context, maintaining state across page navigations and browser sessions, handling encryption of sensitive data, and coordinating communication with external services. Together, these components form a persistent, context-aware execution environment. Communication uses encrypted message passing with keys managed by the service worker. The architecture implements clear separation of concerns: the content script handles DOM interaction, the service worker handles security and persistence, the UI component handles user interaction, and the background page handles business logic.

### Cross-Platform AI Context Bridge

The cross-platform AI context bridge comprises an authenticated session bridge 200, context assembly module 210, element detection engine 220, injection strategy engine 230, chunking module 240, and bidirectional synchronization module 250. These components enable the browser extension to inject structured business context into third-party AI platforms without requiring API integration. The authenticated session bridge 200 maintains the user browser session with both internal and external systems, retrieving context from internal applications using the authenticated session. The context assembly module 210 transforms data from internal systems into structured narrative form suitable for AI injection.

The element detection engine 220 implements sequential detection strategies to locate input elements where context should be injected: identifier-based detection, attribute-based detection, class-based detection, aria-label-based detection, and element-type fallback detection. This cascade approach maximizes compatibility across different AI platforms. The injection strategy engine 230 selects among multiple injection mechanisms: clipboard-event injection, command-based injection, and native-setter injection that directly invokes the input element native value setter to override virtual DOM frameworks. The native-setter injection is particularly valuable for modern applications built with React, Angular, or Vue.

The chunking module 240 divides large contexts into semantically coherent chunks while respecting semantic boundaries and maximum chunk sizes. The bidirectional synchronization module 250 maintains consistency between user input and source context. The no-API approach is fundamental to the architecture, enabling integration with any web-based AI platform without requiring API keys or vendor cooperation. The bridge maintains a context cache to avoid redundant queries, supports multiple injection modes (guided, fast, off), and includes error handling designed for graceful degradation.

### Intelligent Legal Data Acquisition

The intelligent legal data acquisition system comprises a court portal adapter registry 300, jurisdiction-specific adapter modules 310, an overlay interface 320, download controller 330, and multi-stage AI analysis pipeline 340. The court portal adapter registry maintains a catalog of known court portal interfaces and their characteristics including domain, authentication requirements, navigation patterns, and DOM element selectors. Adapter modules implement portal-specific logic including authentication handling, search handling, document listing parsing, and metadata extraction. The overlay interface detects when users navigate to known court portals and presents guided workflows for document discovery.

The download controller 330 manages document retrieval with chunked streaming, handles authentication and SSL/TLS certificate pinning, and implements retry logic. The multi-stage AI analysis pipeline 340 processes documents to extract structured information: filing analyzer stage 341 extracts metadata, classification pipeline stage 342 categorizes documents and extracts legal concepts, and structured observation stage 343 generates summaries. Each stage includes provider fallback chains for resilience. The case law library interface 350 provides access to precedent databases organized by jurisdiction and legal topic.

### Session-authenticated Platform Migration

The session-authenticated platform migration system comprises platform migration adapter registry 400, credential proxy mechanism 410, fallback extraction strategies 420, deep entity extraction module 430, and batched transfer controller 440. The credential proxy mechanism leverages the user authenticated browser session as proxy for authentication between platforms, eliminating the need for users to supply passwords or API keys. Fallback extraction strategies include link-based extraction, table-walk extraction, and platform-specific selector extraction, with successful strategies cached for reuse.

The deep entity extraction module 430 enhances raw data extraction with semantic understanding, identifying relationships between entities and performing entity deduplication. The batched transfer controller 440 manages transferring extracted data by injecting it into destination platform forms using context bridge mechanisms. The process is designed for human visibility and control, with progress tracking, pause capability, and error handling. The system supports concurrent dual-system operation, maintaining synchronization journals to track migrated records and enabling re-sync of user modifications.

### AI Execution Visibility and Interactive Decision Points

The AI execution visibility system comprises execution cursor engine 500, cursor traversal logic 510, click animation renderer 520, step rail interface 530, context chip 540, quick-reply controller 550, serialized execution state 560, visibility mode settings 570, and unified communication inbox 580. The execution cursor engine drives an animated visual cursor synchronized with AI execution, driven by execution event metadata. The cursor traversal logic manages cursor movement through workflow representations, computing cursor position and visual appearance. The click animation renderer creates HTML elements and applies CSS animations for visual presentation.

The step rail interface 530 is an auditable execution trace showing completed, current, and pending steps. The context chip 540 displays current execution context. The quick-reply controller 550 enables users to make decisions at workflow decision points without interrupting execution. The serialized execution state 560 is a structured representation of workflow state persisted to JSON. Workflow interruptibility allows users to pause, review, modify, and resume. Visibility modes include guided mode requiring user approval, fast mode allowing automatic progression, and off mode hiding execution details. The unified communication inbox 580 serves as a hub for execution-related communication with audit trail functionality.

### Vision-based Damage Assessment

The vision-based damage assessment system comprises photo report module 600, AI vision analysis engine 610, weather evidence module 620, pricing database 630, building code rules database 640, estimate generation engine 650, comparison engine 660, estimating software code learning module 670, and crowdsourced pricing platform 680. The photo report module manages photograph collections with EXIF metadata preservation. The AI vision analysis engine analyzes photos using vision models with provider fallback chains for resilience. The weather evidence module correlates damage with weather conditions at loss date and location.

The pricing database 630 maintains current and historical pricing organized hierarchically by component type, subtype, regional variation, and labor costs. The building code rules database 640 maintains applicable construction standards. The estimate generation engine 650 synthesizes evidence sources into itemized estimates with explicit provenance linking. The comparison engine 660 compares independent estimates, classifying findings into agreed, disputed, and missing categories. The learning module 670 implements feedback loops for continuous improvement based on actual repair outcomes. The crowdsourced pricing platform 680 aggregates market data and surfaces market intelligence.

### Federated Execution Protocol

The federated execution protocol comprises cryptographic trust establishment 700, shared room management 740, structured workflow message objects 750, selective replication engine 760, adaptive modality engine 770, append-only event log 780, event synchronization mechanism 790, real-time communication infrastructure 800, and conflict resolution logic 810. Cryptographic trust establishment 700 uses asymmetric keypairs 710 and challenge-response handshakes 720. Federation access tokens 730 are issued upon successful authentication. Shared room management 740 implements record-scoped communication rooms with independent local representations at each node.

Each room has a policy object 741 governing data access and replication. Structured workflow message objects 750 define interchange format including UUID, timestamp, sender identifier, record/room identifier, message type, content, digital signatures, and hash chain linkage. The selective replication engine 760 filters updates with domain classification 761 and AI-aware filtering 762. Dynamic evaluation 763 allows policies to be evaluated based on changing conditions. The adaptive modality engine 770 selects between protocol-enhanced mode 771 using WebRTC and fallback mode 772 using HTTP relay. The append-only event log 780 maintains immutable records with hash chains. Event synchronization mechanism 790 uses version vectors and exponential backoff retry.

Real-time audio-visual communication 800 uses WebRTC infrastructure 801 with session recording 802 and transcription 803. Mesh topology for communication 804 allows direct communication without central relay. Conflict resolution logic 810 applies deterministic ordering based on cryptographic hash of message identifiers when nodes concurrently update the same field. The federated protocol is designed for privacy and autonomy with no central authority, no requirement to trust beyond cryptographic handshake, and policies defined by primary record owner.

### Unified Execution Surface as Control Plane

The unified execution surface 900 is a persistent, user-centric control plane coordinating execution across internal modules, external AI platforms 130, and federated computing nodes 140. The execution surface is the primary user interface displaying step rail and execution cursor, communication inbox, context chips, and quick-reply controls. The surface integrates all six pillars, displaying legal documents from intelligent legal data acquisition, context from AI context bridge, AI execution from external platforms, federated coordination, platform migration, and damage assessment.

The execution surface maintains clear separation between internal modules and external systems, displaying which system is processing each part. Human-in-the-loop decision making is pervasive at every significant decision point. The execution surface provides unified audit trail recording every action, decision, modification, and external communication in chronological, searchable form. The audit trail is cryptographically signed and stored in append-only event logs, preventing tampering or retroactive modification. This design ensures human oversight and accountability throughout.

What is claimed is:

1. A computer-implemented system for cross-platform artificial intelligence context bridging, the system comprising: one or more processors; a non-transitory computer-readable memory storing executable instructions; a transactional application environment comprising a plurality of application modules and structured business records; and a persistent artificial intelligence execution surface rendered within the transactional application environment and functioning as an application-layer control plane abstracted above the plurality of application modules; wherein the executable instructions, when executed by the one or more processors, cause the system to:
(a) maintain, via a browser extension service worker, an authenticated session bridge between the transactional application environment and the browser extension by capturing authentication credentials from the transactional application environment and persisting them in extension-local storage;
(b) assemble, responsive to a user command received within the browser extension, a structured context payload by querying the transactional application environment to retrieve structured record data, associated contact information, key field values, document metadata, and communication history for a selected business record;
(c) detect, via a content script injected into a web page of a third-party artificial intelligence platform, an input element of the third-party artificial intelligence platform by applying a plurality of sequential element detection strategies including identifier-based selection, attribute-based selection, class-based selection, aria-label-based selection, and element-type fallback selection;
(d) inject the assembled structured context payload into the detected input element of the third-party artificial intelligence platform by applying a plurality of sequential injection strategies including clipboard-event-based injection, command-based injection, and native-setter-based injection, wherein at least one injection strategy is specifically configured to bypass client-side synthetic event handling frameworks by invoking native element property setters that circumvent the third-party artificial intelligence platform's virtual document object model event system without triggering synthetic event handlers of the third-party artificial intelligence platform;
(e) when the structured context payload exceeds a predetermined size threshold, automatically partition the payload into a plurality of sequentially labeled message chunks by splitting at semantic boundaries comprising line delimiters or sentence delimiters to preserve contextual coherence, and inject each chunk into the third-party artificial intelligence platform with configurable inter-chunk delays; and
(f) import conversation data from the third-party artificial intelligence platform and associate the imported conversation data with the selected business record in the transactional application environment,
whereby the persistent artificial intelligence execution surface extends its contextual awareness into third-party artificial intelligence platforms without requiring application programming interface integration with the third-party artificial intelligence platforms.

2. The system of claim 1, wherein the browser extension further comprises a citation verification module configured to: extract citation patterns from text generated by the third-party artificial intelligence platform using regular expression matching; transmit each extracted citation to a verified legal database via the authenticated session bridge; compare returned database results against the extracted citations; and render verification indicators distinguishing citations found in the verified database from citations not found in the verified database, thereby identifying potentially hallucinated citations.

3. The system of claim 1, wherein the content script further comprises an auto-send orchestrator configured to: receive an inject-and-send message from the browser extension service worker; inject the structured context payload into the detected input element; locate a submission control element of the third-party artificial intelligence platform using platform-specific selectors; and programmatically activate the submission control element to transmit the injected content without manual user interaction with the submission control.

4. The system of claim 1, wherein the browser extension further comprises a document sharing module configured to: present a selectable list of documents associated with the selected business record; retrieve, for each user-selected document, extracted analysis data including text content, summaries, and classification metadata from the transactional application environment; format the retrieved analysis data with per-document character limits to maintain token efficiency; and inject the formatted document analysis data into the third-party artificial intelligence platform using the plurality of sequential injection strategies.

5. The system of claim 1, wherein the browser extension further comprises a court docket integration module configured to: detect, when a user navigates to a supported court portal website, docket entries displayed on the court portal website; extract filing metadata including filing dates, descriptions, and document identifiers from the detected docket entries; assemble the extracted filing metadata into a structured docket summary; and transmit the structured docket summary to the third-party artificial intelligence platform by locating an active tab displaying the third-party artificial intelligence platform and relaying the structured docket summary via inter-tab messaging.

6. The system of claim 1, wherein the browser extension automatically switches to an artificial intelligence bridge interface tab when the browser extension side panel is opened while the user is viewing a page of the third-party artificial intelligence platform, and wherein control labels dynamically update to reflect the identity of the detected third-party artificial intelligence platform.

7. The system of claim 1, wherein the plurality of sequential element detection strategies are applied in a predetermined order with each successive strategy attempted only upon failure of the preceding strategy, and wherein the system supports at least two distinct third-party artificial intelligence platforms including platforms employing ProseMirror-based rich text editors and platforms employing textarea-based input elements.

8. The system of claim 1, wherein the transactional application environment further comprises case law integration cards, each card configured to present a formatted case summary and to provide direct-to-AI transmission controls that copy case details and inject them into the third-party artificial intelligence platform or open the third-party artificial intelligence platform in a split-view popup window alongside the case law card.

9. The system of claim 1, wherein the third-party artificial intelligence platform is accessed without use of an application programming interface and solely via manipulation of a rendered user interface of the third-party artificial intelligence platform through interaction-layer bridging performed by the content script.

10. The system of claim 1, wherein failure of a first injection strategy of the plurality of sequential injection strategies automatically triggers execution of a subsequent injection strategy without user intervention, and wherein failure of a first element detection strategy of the plurality of sequential element detection strategies automatically triggers execution of a subsequent element detection strategy without user intervention.

11. A computer-implemented system for automated multi-source legal data acquisition and artificial intelligence classification, the system comprising:
one or more processors; a non-transitory computer-readable memory storing executable instructions; and a browser extension comprising a plurality of court portal adapter modules, each adapter module configured to detect a specific court portal website structure; wherein the executable instructions, when executed by the one or more processors, cause the system to:
(a) detect, when a user navigates to a supported court portal website, the court portal website identity by matching the website uniform resource locator against a registry of supported court portal patterns;
(b) inject an overlay interface onto the court portal website, the overlay interface comprising document download controls and range selection controls;
(c) responsive to a user activation of a download control, retrieve one or more document files from the court portal website using the user's authenticated browser session, streaming each document file in configurable-size chunks to a cloud storage system;
(d) create, for each retrieved document file, a docket upload session record comprising source application identifier, filing metadata, case number, and associated party information;
(e) automatically invoke, upon completion of each document upload, a multi-stage artificial intelligence analysis pipeline comprising:
(i) a filing analyzer stage that extracts text from the document, transmits the document to an artificial intelligence processing engine as a native attachment, and receives structured analysis output comprising a document summary, filing type classification, identified key dates with deadline indicators, parties with roles, ruling summary, next actions with urgency levels, risk indicators, and a confidence score;
(ii) a classification pipeline stage comprising sequential artificial intelligence invocations that determine motion type classification, ruling outcome classification, ruling direction classification, and legal analysis including legal basis, cited statutes, cited precedents, and practice area; and
(iii) a structured observation stage that normalizes the analysis output into queryable database records;
(f) store the structured analysis output in association with the docket upload session record; and
(g) present, within a case law library interface, the analyzed documents with filtering by court, practice area, ruling direction, and full-text search, with each document card displaying the classification results and providing action controls for preview, artificial intelligence search, citation copying, and direct-to-AI transmission.

12. The system of claim 11, wherein the plurality of court portal adapter modules comprises at least seven distinct adapters supporting county clerk portals, state circuit court portals, state appellate court portals including single-page application portals that require mutation observation for dynamic content detection, administrative hearing portals, federal court portals, federal government information portals, and state regulatory portals.

13. The system of claim 11, wherein the multi-stage artificial intelligence analysis pipeline employs a provider fallback chain comprising a primary artificial intelligence vision model, a secondary artificial intelligence vision model, and a tertiary artificial intelligence vision model, wherein each subsequent model is invoked only upon failure of the preceding model.

14. The system of claim 11, wherein the case law library interface further comprises a case law analytics module configured to: aggregate classification data across a plurality of analyzed documents; compute statistical breakdowns by court, motion type, ruling direction, judge, cited statute, and year; compute plaintiff and defendant win rate percentages; and render the statistical breakdowns in a visual analytics dashboard.

15. The system of claim 11, further comprising a legal data ingestion system configured to: retrieve jury instruction documents from a legal bar association website and extract text from word processing document XML structures; retrieve court rules documents from a legal bar association website and extract text from portable document format files using font-encoding-aware text extraction; and retrieve statute text from a legislative website and parse hypertext markup language with application-framework-aware content stripping.

16. The system of claim 11, wherein the overlay interface further comprises a send-to-AI control configured to: assemble a structured text block comprising case information and all filing descriptions; locate an active browser tab displaying a third-party artificial intelligence platform by scanning open tabs and sending ping messages to verify content script availability; and relay the structured text block to the located artificial intelligence platform tab for injection into its input element.

17. The system of claim 11, wherein the classification pipeline stage supports batch classification mode that processes a configurable number of documents per batch invocation, enabling bulk retroactive classification of previously imported documents.

18. The system of claim 11, further comprising an appellate brief builder workflow that: receives a trial record upload; extracts facts and legal issues using artificial intelligence analysis; searches the case law library for relevant precedent using the classification data; generates legal arguments with citations exclusively from verified database records; and compiles the generated arguments into a formatted brief with table of contents and table of authorities.

19. A computer-implemented system for session-authenticated cross-platform data migration, the system comprising: one or more processors; a non-transitory computer-readable memory storing executable instructions; a browser extension comprising a plurality of platform migration adapter modules; and a target transactional application environment configured to receive migrated data; wherein the executable instructions, when executed by the one or more processors, cause the system to:
(a) detect, when a user navigates to a legacy platform website, the legacy platform identity by matching the website uniform resource locator against a registry of supported legacy platform patterns;
(b) extract entity data from the legacy platform website using the user's authenticated browser session as a credential proxy that enables access to protected resources without exposing authentication tokens to the system and without exposing authentication tokens outside the browser execution environment, without requiring application programming interface credentials or vendor-provided integration mechanisms, wherein the extraction employs a plurality of fallback extraction strategies comprising:
(i) a link-based extraction strategy that identifies hyperlink elements containing entity identifiers in their uniform resource locator paths;
(ii) a table-walk extraction strategy that parses tabular data structures by detecting column headers and extracting row data; and
(iii) a platform-specific selector extraction strategy that targets document object model elements unique to the detected legacy platform, wherein each fallback extraction strategy is conditionally invoked based on detection of failure states in a preceding strategy;
(c) for each extracted entity, perform deep entity extraction by making authenticated application programming interface requests to the legacy platform using the user's browser session cookies, retrieving nested data objects comprising notes, documents, activities, time entries, relationships, contacts, and custom field values;
(d) transmit the extracted data to the target transactional application environment in batched transfer messages comprising a migration start message, a plurality of data batch messages each containing a page of entity records, entity completion messages, and file upload messages for document attachments;
(e) create, in the target transactional application environment, corresponding structured business records with associated contacts, documents, notes, and activity records linked to their respective business records; and
(f) provide the user with immediate access to artificial intelligence features of the target transactional application environment including artificial intelligence inbox capabilities, document analysis, and conversational artificial intelligence assistance for the migrated business records,
whereby the user can operate both the legacy platform and the target transactional application environment concurrently during a transition period without data loss or manual re-entry.

20. The system of claim 19, wherein the plurality of platform migration adapter modules comprises adapters for at least three distinct legacy legal practice management platforms, each adapter configured to normalize platform-specific entity schemas into a common migration data format.

21. The system of claim 19, wherein the browser extension further comprises a migration status interface displaying extraction progress indicators, entity counts, and completion status for each entity type being migrated.

22. The system of claim 19, wherein the deep entity extraction further comprises document file retrieval that downloads document attachments from the legacy platform using the user's browser session and uploads each document to cloud storage associated with the target transactional application environment.

23. The system of claim 19, further comprising a regulatory filing auto-fill module configured to: detect when the user navigates to a government regulatory filing portal; populate form fields of the regulatory filing portal with data from a selected business record in the target transactional application environment; handle conditional form field visibility by inserting delays before populating conditionally revealed fields; and handle platform-specific form validation events.

24. The system of claim 19, wherein the plurality of fallback extraction strategies are applied in a predetermined order with each successive strategy attempted only upon failure of the preceding strategy, and wherein the user may select specific entities for migration using native selection controls of the legacy platform website.

25. The system of claim 19, wherein the user is enabled to operate both the legacy platform and the target transactional application environment concurrently while background synchronization continues, and wherein migrated data in the target transactional application environment is immediately available for artificial intelligence processing including document analysis, conversational assistance, and automated workflow operations without waiting for full migration completion.

26. A computer-implemented system for real-time artificial intelligence execution visibility with interactive human decision points, the system comprising:
one or more processors; a non-transitory computer-readable memory storing executable instructions; a transactional application environment comprising a plurality of application modules and structured business records; and a persistent artificial intelligence execution surface rendered within the transactional application environment; wherein the executable instructions, when executed by the one or more processors, cause the system to:
(a) render an animated execution cursor element within the persistent artificial intelligence execution surface, the cursor element comprising a visually distinct indicator that traverses to target user interface elements corresponding to application modules being accessed by the artificial intelligence processing engine, wherein traversal of the cursor element is determined based on execution event metadata emitted by the artificial intelligence processing engine, the cursor element further comprising a click animation effect rendered upon each artificial intelligence interaction with a target element and an action label displaying a human-readable description of the current artificial intelligence operation;
(b) maintain a step rail interface element comprising a chronologically ordered log of artificial intelligence execution events, each event entry displaying an execution status indicator, an event description, and a relative timestamp, the step rail interface element configured to automatically expand when artificial intelligence execution begins and automatically collapse after a configurable period of inactivity;
(c) render a context chip element displaying the identity of the active structured business record within which the artificial intelligence is operating;
(d) emit execution events from each stage of a staged artificial intelligence workflow, each execution event comprising an event type, a target element selector mapping to a user interface element, an execution status, and descriptive detail text;
(e) when the artificial intelligence processing engine reaches a decision point requiring human input during a staged workflow, render a plurality of selectable quick-reply option controls within a chat input area of the persistent artificial intelligence execution surface, each option control representing a distinct action path;
(f) responsive to user selection of one of the plurality of quick-reply option controls, modify a serialized execution state to incorporate the selected action, display a visible confirmation message in the conversational interface indicating the selected action, and resume the staged workflow from the prior interruption point with the selected action path without recomputation of prior workflow steps and without reissuing prior artificial intelligence processing requests; and
(g) provide a user-configurable visibility mode setting that controls the level of execution transparency, the visibility mode setting comprising at least:
(i) a guided mode rendering the animated execution cursor with click effects and the step rail in expanded form;
(ii) a fast mode hiding the cursor and rendering only a collapsed floating indicator with an activity count; and
(iii) an off mode hiding all execution visibility elements while continuing to display workflow results.

27. The system of claim 26, wherein the animated execution cursor element traverses to target user interface elements using smooth animated transitions with configurable duration and easing, and wherein the click animation effect comprises an expanding ripple visualization rendered at the target element coordinates.

28. The system of claim 26, wherein the step rail interface element displays a maximum number of most recent execution events and wherein each event entry transitions through status states comprising in-progress with a spinner indicator, completed with a success indicator, and failed with an error indicator.

29. The system of claim 26, wherein the quick-reply option controls further comprise a compose choice bar for communication operations, the compose choice bar presenting a first stage of communication channel options and a second stage of composition mode options responsive to the user's first-stage selection.

30. The system of claim 26, wherein the target element selector mapping comprises a predefined registry mapping artificial intelligence operation types to user interface element data attributes, the operation types including at least matters search, emails search, documents search, calendar creation, and task creation.

31. The system of claim 26, further comprising a unified communication inbox aggregating communications from at least seven distinct channels comprising email, short message service, telephone calls, client update requests, direct messages, system activity events, and internal notes into a single chronological stream interface with channel-specific filtering controls.

32. The system of claim 31, wherein the unified communication inbox further comprises an artificial intelligence routing intelligence module configured to: analyze each inbound communication using the artificial intelligence processing engine; generate a routing suggestion associating the communication with a structured business record; assign a confidence score to the routing suggestion; present the routing suggestion in a suggested routing interface; and maintain a three-state lifecycle for each communication comprising unrouted, suggested, and routed states with undo capability.

33. The system of claim 26, further comprising a personal external platform connector system configured to: authenticate with external non-business platforms via OAuth authorization flows; normalize events from the connected external platforms into a common event schema; surface connected platform controls as selectable icons within a chat bar of the persistent artificial intelligence execution surface; and merge normalized platform events into the unified communication inbox stream.

34. The system of claim 26, wherein the staged workflow is interruptible at defined decision points and resumable without recomputation of prior steps, and wherein a serialized execution state is persisted at each decision point to enable restoration of the workflow to the exact interruption state.

35. The system of claim 26, wherein the step rail interface element constitutes an auditable execution trace that records each artificial intelligence operation with timestamp, operation type, target element, execution status, and descriptive detail, and wherein the execution trace is persistently stored in association with the structured business record for compliance and review purposes.

36. A computer-implemented system for vision-based property damage assessment with automated estimate generation and dispute analysis, the system comprising: one or more processors; a non-transitory computer-readable memory storing executable instructions; a photo report module configured to receive uploaded photographic images of property damage; a weather evidence module configured to query a plurality of weather data providers; a pricing database comprising regional unit costs for materials, labor, and equipment; and an estimate generation engine; wherein the executable instructions, when executed by the one or more processors, cause the system to:
(a) for each uploaded photographic image, invoke an artificial intelligence vision analysis engine using a provider fallback chain to produce structured damage observations comprising: damage type classifications across a plurality of predefined damage categories, material identifications, severity assessments on a multi-level severity scale, confidence scores, estimated affected area measurements, location identifications within the structure, and repair recommendations;
(b) store each structured damage observation in association with the photographic image, comprising damage category, subcategory, severity level, estimated measurements, observation source indicator, and bounding box coordinates;
(c) query, using a property address and date range, the plurality of weather data providers simultaneously to retrieve weather event data, and classify each retrieved weather event by severity based on hail size and wind speed thresholds;
(d) generate, via the estimate generation engine, a repair cost estimate by:
(i) reading the structured damage observations to determine scope of damage;
(ii) reading the classified weather event data to establish loss causation evidence;
(iii) retrieving regional unit costs from the pricing database adjusted by regional cost factor multipliers;
(iv) applying jurisdiction-specific building code rules to determine code-driven scope requirements; and
(v) applying jurisdiction-specific overhead and profit regulations to calculate overhead and profit amounts;
(e) produce estimate line items, each line item comprising an item code, category, description, quantity with unit designation, three-part pricing comprising material cost, labor cost, and equipment cost, a provenance indicator explicitly linking the line item to one or more of the independent evidence sources comprising the structured damage observations, the classified weather event data, the regional pricing database, and the jurisdiction-specific building code rules, and an artificial intelligence reasoning explanation;
(f) import a counterparty estimate document by parsing the counterparty estimate document using artificial intelligence vision analysis to extract structured line items, quantities, units, pricing, and estimating software codes; and
(g) compare the generated repair cost estimate against the imported counterparty estimate to produce comparison findings, each finding comprising a finding type, a severity classification, a monetary difference amount, and a recommendation,
wherein finding types comprise at least omission findings for items present in one estimate but absent from the other, measurement discrepancy findings, pricing discrepancy findings, scope disagreement findings, building code violation findings, and access issue findings, and wherein each comparison finding is linked to both the source estimate line items and the underlying evidence supporting the finding.

37. The system of claim 36, wherein the plurality of weather data providers comprises at least four providers including premium hail-tracking providers, premium forecast providers, and a free meteorological data provider, and wherein the weather evidence module filters weather events to include only events exceeding minimum thresholds for wind speed or precipitation accumulation.

38. The system of claim 36, wherein the pricing database further comprises: a labor rates table storing trade-specific hourly rates by region with statistical distribution data; a cost indices table tracking historical price trends including consumer price index, producer price index, and construction cost indices with year-over-year change calculations; and a building code rules table storing code-driven scope requirements indexed by jurisdiction and applicable building code standard.

39. The system of claim 36, further comprising an estimating software code learning module configured to: scan imported estimate line items for estimating software codes; automatically map newly encountered codes to internal category taxonomy with an auto-mapped source indicator; increment encounter counts and update pricing statistics for previously encountered codes; and improve mapping accuracy over time from imported real-world estimate data.

40. The system of claim 36, further comprising a crowdsourced pricing platform configured to: receive estimate submissions from external contributors; strip personally identifiable information from submitted estimates; score submission quality based on completeness, consistency, and outlier detection; publish aggregated pricing data only when a minimum sample size threshold is met and no single source exceeds a maximum contribution percentage; and compute aggregated statistics comprising median, mean, and percentile distributions segmented by source type and geographic region.

41. The system of claim 36, wherein the photo report module further comprises: sequential exhibit labeling that automatically assigns exhibit identifiers to uploaded photographs; room-based grouping of photographs; configurable page layout styles specifying the number of photographs per page; and a portable document format report generator that produces a downloadable report comprising a title page, photographed exhibits with exhibit labels, timestamps, user comments, and artificial intelligence captions, and a damage summary narrative.

42. The system of claim 36, wherein the estimate generation engine further reads additional living expense data associated with the business record and includes additional living expense line items in the generated repair cost estimate.

43. The system of claim 36, wherein the comparison findings further comprise an artificial intelligence narrative summary describing the overall dispute between the generated estimate and the counterparty estimate, and wherein each comparison finding is linked to the specific line items and evidence supporting the finding.

44. The system of claim 36, wherein imported counterparty estimates update internal pricing mapping accuracy over time by incorporating newly encountered line item codes, unit costs, and quantity patterns into the pricing database, thereby enabling progressive improvement of estimate generation accuracy from imported real-world estimate data.

45. A computer-implemented system for federated cross-organizational coordination via persistent artificial intelligence execution surfaces, the system comprising: a plurality of computing nodes, each computing node comprising one or more processors, non-transitory computer-readable memory, a transactional application environment with application modules and structured business records, and a persistent artificial intelligence execution surface functioning as an application-layer control plane; a cryptographic trust establishment mechanism comprising:
(i) an asymmetric keypair for each computing node, comprising a private key stored encrypted in a node credential store and a public key registered with peer nodes;
(ii) a challenge-response handshake protocol wherein an initiating node generates a nonce, signs the nonce with its private key, transmits the signed nonce to a responding node, the responding node verifies the signature against the initiating node's public key, signs its own nonce, and returns the signed nonce for mutual verification; and
(iii) federation access tokens minted upon successful handshake completion, each token comprising issuer identification, subject identification, room scope, permission scopes, and expiration timestamp, transmitted in request headers for all subsequent cross-node communications;
a shared room management system configured to create record-scoped collaboration namespaces, each shared room comprising a shared room identifier mapped to independent local structured business records at each participating computing node, wherein each shared room maintains independent local representations of a common logical record and wherein event synchronization preserves referential integrity between the independent representations, and a policy object specifying replication rules, artificial intelligence visibility levels, recording rules, and presence visibility;
a structured workflow message object exchange mechanism configured to generate, transmit, receive, and process typed message objects comprising at least document transfer objects, schedule proposal objects, deadline proposal objects, and acknowledgment objects, each message object validated against a message schema prior to transmission;
a selective replication engine configured to enforce domain-scoped replication policies that classify event domains into shared domains that are replicated to peer nodes and internal-only domains that are prevented from leaving the originating node, wherein replication policies are dynamically evaluated based on event domain classification and artificial intelligence context sensitivity;
an adaptive modality engine configured to: detect whether a communication counterparty operates a compatible computing node; select a protocol-enhanced communication mode when the counterparty is compatible, the protocol-enhanced mode comprising structured message objects with acknowledgment tracking and selective replication; and select a fallback communication mode when the counterparty is not compatible, the fallback mode comprising legacy unstructured communication channels;
an append-only event log wherein each event comprises a cryptographic signature of the originating node, a hash of the preceding event in the same room forming a hash chain for tamper-evident integrity verification, an event domain classification, and a typed event payload; and
an event synchronization mechanism configured to replicate events from the append-only event log to peer computing nodes via authenticated sessions, with reliable delivery comprising an outbound queue with exponential backoff retry logic and a dead letter queue for events that exceed a maximum retry count,
wherein the shared room management system is integrated with the persistent artificial intelligence execution surface at each computing node to synchronize execution state across nodes, and wherein each computing node presents a unified experience through its persistent artificial intelligence execution surface that incorporates both local application data and federated data received from peer computing nodes through the shared room management system.

46. The system of claim 45, wherein the persistent artificial intelligence execution surface at each computing node further comprises a coordinated dual-surface interface comprising an artificial intelligence conversational panel and an editable composition panel, and wherein content composed in the composition panel is transmitted to peer computing nodes as structured workflow message objects through the protocol-enhanced communication mode.

47. The system of claim 46, further comprising real-time artificial intelligence content streaming from the artificial intelligence conversational panel into the composition panel prior to transmission to peer computing nodes, and keystroke-level intent detection that routes user input to the artificial intelligence conversational panel or the composition panel based on input characteristics.

48. The system of claim 45, further comprising cross-node multi-stage execution wherein a staged workflow initiated at a first computing node generates proposed actions that affect a structured business record at a second computing node, the second computing node rendering a human approval interface for the proposed actions, and the second computing node transmitting a structured approval status object comprising approval, modification, or rejection back to the first computing node.

49. The system of claim 48, wherein the multi-stage execution further comprises schema validation of artificial intelligence outputs at each computing node before persistence and before transmission to peer computing nodes, and serialized execution state associated with the shared room for restoration upon interruption.

50. The system of claim 45, wherein the document transfer objects further comprise a document identifier, document metadata, an acknowledgment requirement indicator, and a response deadline, and wherein the system automatically generates follow-up notifications when an acknowledgment is not received within the response deadline.

51. The system of claim 45, further comprising a record-scoped artificial intelligence memory module at each computing node that incorporates shared-room events received from peer computing nodes into per-record artificial intelligence session history, with compressed summary injection of federated interaction history for token-efficient artificial intelligence context assembly.

52. The system of claim 45, further comprising a provider-agnostic artificial intelligence dispatch module at each computing node with capability gap detection, wherein artificial intelligence outputs generated via the dispatch module are subject to the selective replication policies of the shared room before transmission to peer computing nodes.

53. The system of claim 45, further comprising real-time audio-visual communication within shared rooms using peer-to-peer connections established via a signaling channel, with a configurable communication policy enforced at both client-side and server-side, session lifecycle events recorded as structured workflow message objects subject to selective replication, and multi-party connections supporting a configurable maximum number of simultaneous participants.

54. The system of claim 53, further comprising a mesh topology manager implementing polite-peer negotiation wherein the node with a lower identifier transmits connection offers, with per-peer candidate queues for connection establishment.

55. The system of claim 53, further comprising a multi-view interface comprising a gallery view with responsive grid layout, a speaker view with dominant speaker display and sidebar participant thumbnails, and a screen-sharing view, with view transitions driven by an active speaker detection module that analyzes audio energy levels with hysteresis thresholds.

56. The system of claim 53, further comprising screen sharing via display media acquisition with track replacement on all peer connections and preservation of original media tracks for restoration upon screen sharing cessation.

57. The system of claim 53, further comprising a document co-review module presenting a split-panel layout with a resizable document viewer during an active audio-visual communication session, the document co-review module supporting synchronized navigation across participants, independent navigation mode, and real-time annotation broadcast, with reviewed document identifiers automatically associated with the session lifecycle event for auditable review linking.

58. The system of claim 53, further comprising a session recording module configured to: present a consent dialog to all participants; capture local and remote media streams upon consent; upload the captured recording to secure storage; display a visual recording indicator during active recording; and emit recording lifecycle events as structured workflow message objects.

59. The system of claim 58, further comprising a transcription module configured to process recorded audio using provider-agnostic speech-to-text services, and an artificial intelligence summary generation module configured to produce a structured summary comprising key discussion points with confidence scores, identified action items, and an editable summary interface for human review prior to finalization, the summary and transcript subject to the selective replication policies of the shared room.

60. The system of claim 53, further comprising a call scheduling module configured to create scheduled audio-visual communication sessions with calendar integration, countdown timer display, and automatic join prompt at scheduled time.

61. The system of claim 45, further comprising an availability signaling module providing real-time presence indicators for participants within shared rooms and a knock notification mechanism for requesting attention from participants at peer computing nodes, with presence state comprising at least online, in-room, in-call, away, and offline states.

62. The system of claim 45, wherein artificial intelligence outputs generated at one computing node are filtered through the replication policies of the selective replication engine prior to transmission to peer computing nodes, such that artificial intelligence analysis containing internal-only data classifications is prevented from crossing organizational boundaries.

63. The system of claim 45, further comprising conflict resolution logic for reconciling concurrent updates across computing nodes, wherein the conflict resolution logic applies a deterministic ordering based on event timestamps and originating node identifiers to resolve conflicting modifications to shared room state.

64. A computer-implemented method for extending a persistent artificial intelligence execution surface across organizational boundaries and into third-party artificial intelligence platforms, the method performed via a browser extension executing within a client device and interacting with rendered user interface elements of third-party systems, the method comprising:
(a) maintaining, at a first computing node, a persistent artificial intelligence execution surface functioning as an application-layer control plane above a plurality of application modules;
(b) assembling, responsive to a user command received via a browser extension, a structured context payload from the first computing node by retrieving structured record data, contact information, key field values, document metadata, and communication history for a selected business record;
(c) detecting an input element of a third-party artificial intelligence platform displayed in a browser tab by applying a plurality of sequential element detection strategies;
(d) injecting the assembled structured context payload into the detected input element using a plurality of sequential injection strategies, wherein the injection and detection operations are performed without use of external application programming interfaces of the third-party artificial intelligence platform;
(e) establishing a cryptographic trust relationship with a second computing node via a challenge-response handshake protocol using asymmetric key signatures;
(f) creating a shared record-scoped collaboration namespace mapping a shared room identifier to independent local structured business records at the first computing node and the second computing node;
(g) generating structured workflow message objects and transmitting the message objects to the second computing node via an authenticated session;
(h) enforcing selective replication policies that prevent internal-only event domains from being transmitted to the second computing node;
(i) detecting whether a communication counterparty operates a compatible computing node and automatically selecting a protocol-enhanced communication mode or a fallback communication mode;
(j) rendering, within the persistent artificial intelligence execution surface, an animated execution cursor that traverses to target user interface elements corresponding to artificial intelligence operations, a step rail log of execution events, and quick-reply decision controls at workflow decision points; and
(k) receiving uploaded photographic images, invoking artificial intelligence vision analysis to produce structured damage observations, querying weather data providers for loss causation evidence, and generating repair cost estimates by combining damage observations with regional pricing data, building code rules, and overhead and profit regulations.

65. A non-transitory computer-readable medium storing executable instructions that, when executed within a browser extension environment comprising a content script and service worker by one or more processors of a computing system, cause the computing system to:
(a) render a persistent artificial intelligence execution surface functioning as an application-layer control plane above a transactional application environment comprising a plurality of application modules and structured business records;
(b) maintain an authenticated session bridge with a browser extension and, responsive to user commands, assemble structured context payloads and inject them into third-party artificial intelligence platforms via content script bridges using sequential element detection and injection strategies;
(c) verify citations extracted from third-party artificial intelligence platform outputs against a verified legal database and render verification indicators distinguishing verified citations from potentially hallucinated citations;
(d) detect supported court portal websites, inject overlay interfaces for document downloading, and automatically invoke multi-stage artificial intelligence analysis pipelines producing structured classification data;
(e) extract entity data from legacy platform websites using authenticated browser sessions without application programming interface credentials and migrate the extracted data to the transactional application environment;
(f) render an animated execution cursor, step rail log, and context chip displaying real-time artificial intelligence execution progress, and present quick-reply decision controls at staged workflow decision points;
(g) aggregate communications from a plurality of channels into a unified inbox with artificial intelligence routing suggestions and confidence scores;
(h) establish cryptographic trust with peer computing nodes, create shared record-scoped collaboration namespaces, exchange structured workflow message objects, enforce selective replication policies, and automatically select protocol-enhanced or fallback communication modes based on counterparty capability detection;
(i) conduct real-time audio-visual communication sessions within shared collaboration namespaces using peer-to-peer connections with policy-governed access control, session recording with consent, automated transcription, and artificial intelligence summary generation; and
(j) receive photographic images, produce structured damage observations via artificial intelligence vision analysis, correlate weather evidence for loss causation, generate repair cost estimates using regional pricing databases and jurisdiction-specific rules, import counterparty estimates, and compare estimates to produce dispute findings with severity classifications and recommendations.

66. A federated computer-implemented system comprising: a first computing node comprising a first transactional application environment, a first persistent artificial intelligence execution surface functioning as an application-layer control plane, and a first asymmetric keypair; a second computing node comprising a second transactional application environment, a second persistent artificial intelligence execution surface, and a second asymmetric keypair; a cryptographic trust relationship established between the first computing node and the second computing node via a challenge-response handshake protocol; a shared record-scoped collaboration namespace mapping a shared room identifier to a first local structured business record at the first computing node and a second local structured business record at the second computing node; a structured workflow engine configured to generate, validate, transmit, and process typed workflow message objects between the first computing node and the second computing node; a selective replication engine at each computing node enforcing domain-scoped policies that prevent internal-only event domains from crossing organizational boundaries; an adaptive modality engine configured to automatically select protocol-enhanced structured communication when both nodes are compatible or fallback unstructured communication otherwise; a browser extension at the first computing node comprising a cross-platform artificial intelligence context bridge configured to inject structured context from the first transactional application environment into third-party artificial intelligence platforms; and an embeddable software development kit enabling third-party application environments to participate in the federated system by rendering an execution surface instance, bridging local application context to the structured workflow engine, and registering with the cryptographic trust mechanism.

67. A computer-implemented system comprising: one or more processors; a non-transitory computer-readable memory storing executable instructions; and a persistent artificial intelligence execution surface operating as a unified control plane; wherein the executable instructions, when executed by the one or more processors, cause the persistent artificial intelligence execution surface to coordinate operations across:
(i) internal application modules of a transactional application environment comprising structured business records, a unified communication inbox, document management, and task management;
(ii) third-party artificial intelligence platforms accessed without application programming interface integration or vendor-provided integration mechanisms and solely via browser extension content scripts that detect input elements using sequential element detection strategies and inject structured context payloads using sequential injection strategies that bypass synthetic event handling frameworks via interaction-layer manipulation of rendered user interfaces; and
(iii) federated computing nodes operated by independent organizations, coordinated via cryptographic trust establishment, shared record-scoped collaboration namespaces with independent local representations, structured workflow message object exchange, and selective replication policies that prevent internal-only data from crossing organizational boundaries;
wherein each of (i), (ii), and (iii) are coordinated through a unified execution state and event-driven messaging architecture maintained by the persistent artificial intelligence execution surface;
wherein the persistent artificial intelligence execution surface further provides:
human-supervised autonomous execution comprising an animated execution cursor driven by execution event metadata, a step rail constituting an auditable execution trace, and interactive quick-reply decision controls at workflow interruption points that modify serialized execution state and resume workflow execution without recomputation of prior steps;
session-authenticated data migration from legacy platforms using the user's browser session as a credential proxy without requiring application programming interface credentials; and
vision-based damage assessment integrating multiple independent evidence sources comprising photographic analysis, weather correlation, regional pricing, and jurisdiction-specific building code rules, with explicit provenance linking each estimate line item to its supporting evidence,
whereby the persistent artificial intelligence execution surface functions as a single orchestration layer bridging local application operations, external artificial intelligence capabilities, and cross-organizational federated workflows into a unified human-supervised execution environment.

68. The system of claim 1, wherein failure of any operation within the plurality of sequential element detection strategies or the plurality of sequential injection strategies results in automatic invocation of an alternative strategy without user intervention and without loss of execution state, and wherein failure of any stage within a staged artificial intelligence workflow results in preservation of the serialized execution state at the point of failure enabling recovery and resumption without recomputation or reissuing of prior artificial intelligence processing requests.
